(19) United States
(12) Patent Application Publication
(10) Pub. No.: US 2024/0237824 A1
(43) Pub. Date: Jul. 18, 2024

(54) ANTI-OVERTURNING CABINET STRUCTURE

(71) Applicant: Chroma ATE INC., Taoyuan (TW)

(72) Inventors: SHENG-CHING CHUANG, Taoyuan (TW); Tung-Hsing Wu, Taoyuan (TW)

(21) Appl. No.: 18/414,549

(22) Filed: Jan. 17, 2024

(30) Foreign Application Priority Data
Jan. 18, 2023 (TW) 115102361

(51) Int. Cl. A47B 97/00; B60B 33/00

(52) U.S. Cl. CPC A47B 97/00; B60B 33/0002; A47B 2097/008

(57) ABSTRACT

An anti-overturning device for cabinet and its cabinet structure is disclosed in the present invention. The anti-overturning device comprises a first fixing member, a second fixing component and a connecting part. The first fixing component is used for arranging detachably on the outside of the cabinet bottom. The second fixing component includes at least a second opening, and the second opening is used for fixing on the auxiliary wheel or on the ground. The anti-overturning devices are provided evenly on the periphery of the cabinet bottom. The anti-overturning devices change the horizontal position of the original overturning pivot of the cabinet and enlarge the overturning angle to prevent from overturning the cabinet.

### CROSS-REFERENCE TO RELATED APPLICATIONS

This patent application claims priority under 35 U.S.C. § 119(a) on Patent Application No(s). 112102361 filed in Taiwan on Jan. 18, 2023 the entire contents of which are hereby incorporated by reference.

### BACKGROUND OF THE INVENTION

### Field of the Invention

The invention relates to an anti-overturning cabinet structure. The cabinet is used to store objects, which can be moved or positioned on the floor for use by means of wheels. The anti-overturning device is arranged on the bottom outer surface of the cabinet, which is used to assist in the movement or positioning of the cabinet, and to prevent the cabinet from turning over during the movement.

### Description of the Related Art

Conventional cabinets (such as ordinary iron cabinets, welded cabinets or extruded aluminum cabinets) are used to store objects. Wheels are installed at the bottom of the cabinet to facilitate transportation. In the process of transportation of the cabinet through the sliding wheels, if the wheels accidentally get stuck in the ground or hit the bumps on the ground, it is easy for the cabinet to fall forward. Accordingly, a heavy fall on the cabinet or its objects will not only cause inconvenience in transportation, but will also result in economic loss if the cabinet or its objects is damaged after the heavy fall.

In particular, many electronic industries currently utilize cabinets to house their computing equipment. As a result, in addition to serious economic losses, the relevant operational functions and services of the computing equipment will also be affected.

### BRIEF SUMMARY OF THE INVENTION

An anti-overturning device is installed on the cabinet by the present invention. The anti-overturning device can increase the angle at which the cabinet turns over, making it difficult for the cabinet to turn over during the sliding movement. The anti-overturning device assists in smoothing the movement of the cabinet during sliding and stabilizing the positioning of the cabinet, which is the solution provided by the present invention.

The anti-overturning cabinet structure of the present invention includes a cabinet, a plurality of anti-overturning devices and a plurality of auxiliary wheels. A bottom outer surface of the cabinet has an upper fixing area and a lower fixing area. Each of the anti-overturning devices has a first fixing component, a second fixing component and a connecting part. The first fixing component is detachably fixed on the bottom outer surface of the cabinet, the second fixing component has at least one second opening, and the connecting part is joined between the first fixing component and the second fixing component. The anti-overturning devices comprises at least one first anti-overturning device and at least one second anti-overturning device, the number of the first anti-overturning devices is equal to the number of the second anti-overturning devices, they are optionally disposed on two opposite sides of the upper fixing area or the lower fixing area. When the first anti-overturning devices and the second anti-overturning devices are fixed on the upper fixing area, each auxiliary wheel is locked in the second opening of each of the second fixing components.

In a preferred embodiment, the first anti-overturning devices are disposed on a front side of the upper fixing area, the second anti-overturning devices are disposed on a back side of the upper fixing area, and positions of the first anti-overturning devices correspond to positions of the second anti-overturning devices.

In a preferred embodiment, the first anti-overturning devices are disposed on a front side of the lower fixing area, the second anti-overturning devices are disposed on a back side of the lower fixing area, and positions of the first anti-overturning devices correspond to positions of the second anti-overturning devices.

In a preferred embodiment, an anti-overturning distance is used to calculate an anti-overturning angle, and a calculation formula of the anti-overturning angle is as follows:

$${tan}^{- 1} \frac{L 1 + L 3}{L 2} ;$$

wherein in the calculation formula, L1 is the anti-overturning distance, L2 is a vertical distance from a gravity center of the cabinet to a bottom surface of the cabinet, and L3 is a horizontal distance from the gravity center of the cabinet to an outer surface of the cabinet.

In a preferred embodiment, one end of the first fixing component is joined to one end of the second fixing component.

In a preferred embodiment, the first fixing component is vertical to the second fixing component.

In a preferred embodiment, the connecting part comprises two connecting plates, and the connecting plates are respectively joined to both sides of the first fixing component and the second fixing component.

In a preferred embodiment, the connecting part comprises a connecting plate, and the connecting plate is joined to two adjacent surfaces of the first fixing component and the second fixing component.

### BRIEF DESCRIPTION OF THE DRAWINGS

FIG. 1 illustrates the first embodiment of the anti-overturning cabinet structure of the present invention and a partial three-dimensional schematic diagram of the cabinet and the auxiliary wheel before being assembled.

FIG. 2 illustrates the first embodiment of the anti-overturning cabinet structure of the present invention and a partial three-dimensional schematic diagram of the cabinet and the auxiliary wheel after being assembled.

FIG. 3 illustrates the first embodiment of the anti-overturning cabinet structure of the present invention and a partial front view schematic diagram of the cabinet and the auxiliary wheel after being assembled.

FIG. 4 illustrates the first embodiment of the anti-overturning cabinet structure of the present invention and a partial cross-sectional (the cutting direction of the cross-section is shown in the section line A-A of FIG. 3) schematic diagram of the cabinet and the auxiliary wheel after being assembled.

FIG. 5 illustrates the first embodiment of the anti-overturning cabinet structure of the present invention and a partial three-dimensional schematic diagram of the cabinet and the ground before being assembled.

FIG. 6 illustrates the first embodiment of the anti-overturning cabinet structure of the present invention and a partial three-dimensional schematic diagram of the cabinet and the ground after being assembled.

FIG. 7 illustrates the first embodiment of the anti-overturning cabinet structure of the present invention and a partial cross-sectional (the cutting direction of the cross-section is shown in the section line B-B of FIG. 6) schematic diagram of the cabinet and the ground before being assembled.

FIG. 8 illustrates the three-dimensional schematic diagram of the anti-overturning cabinet structure of the present invention.

FIG. 9A is a schematic diagram of the anti-overturning cabinet structure of the present invention when the anti-overturning device is installed and has not yet tipped over.

FIG. 9B is a schematic diagram of the overturning angle when the anti-overturning cabinet structure of the present invention is not equipped with an anti-overturning device.

FIG. 9C is a schematic diagram of the overturning angle when the anti-overturning cabinet structure of the present invention is equipped with an anti-overturning device.

FIG. 10 illustrates the second embodiment of the anti-overturning cabinet structure of the present invention and a partial three-dimensional schematic diagram of the cabinet and the auxiliary wheel before being assembled.

FIG. 11 illustrates the third embodiment of the anti-overturning cabinet structure of the present invention and a partial three-dimensional schematic diagram of the cabinet and the auxiliary wheel before being assembled.

FIG. 12 illustrates the fourth embodiment of the anti-overturning cabinet structure of the present invention and a partial three-dimensional schematic diagram of the cabinet and the auxiliary wheel before being assembled.

### DETAILED DESCRIPTION OF THE INVENTION

Other technical contents, features and effects of the present invention will be clearly presented in the following detailed description of the preferred embodiment with reference to the drawings.

As used herein, the term “on” used to describe the position of a structure refers to any surface position of the structure, and is not commonly referred to as the directional “above” or “on”. The terms “above” and “below” used to describe the position of a structure refer to the directionality of the position of the structure in conventional use.

As used herein, the term “bottom” describing the location of a structure does not uniquely and specifically refer to the face or end at the bottom of the structure, but rather refers to the face or end at the bottom of the structure, as well as to each location adjacent to and around the bottom, but does not encompass the area above the horizontal center of the structure.

As used herein, the article “a” as well as “one” are grammatical references to one or more (i.e., at least one) items, when no specific number is specified. For example, “one component” means one component or more than one component.

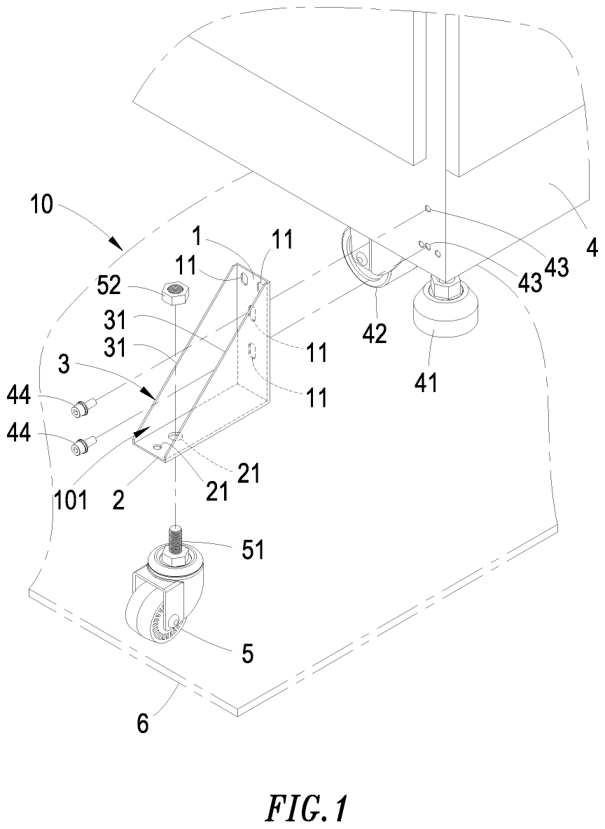

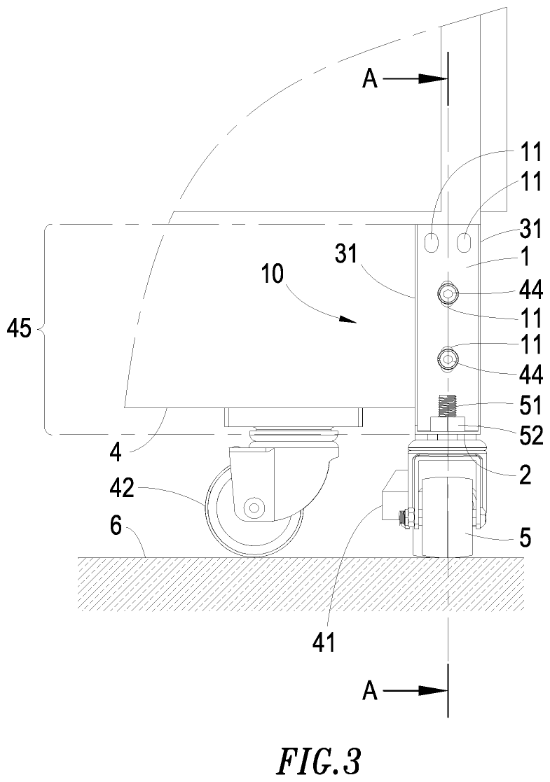

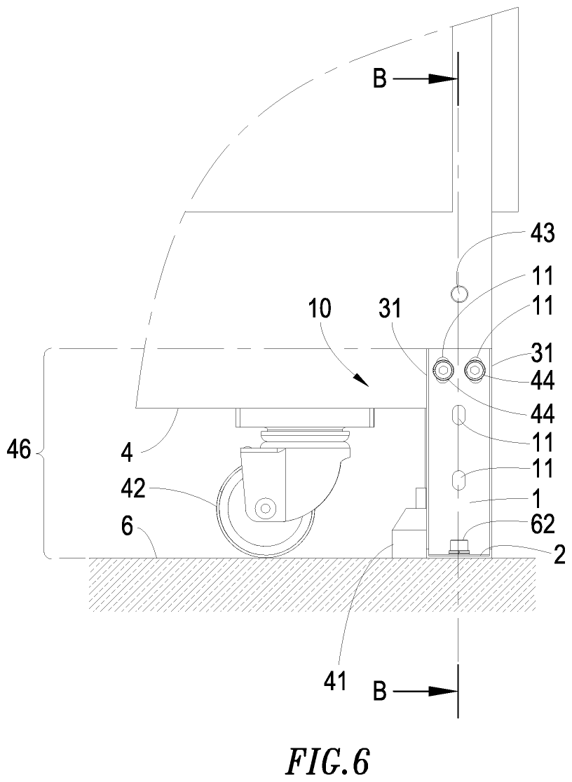

Please refer to FIG. 1, which illustrates a first embodiment of the anti-overturning device 10 and a cabinet 4 of the present invention. The bottom of the cabinet 4 includes a bottom surface facing the ground 6 and an outer surface perpendicular to the bottom surface. The adjacent positioning column 41 and the bottom wheel 42 are disposed on the bottom surface. The positioning column 41 is used to position the cabinet 4 at a fix point, and the bottom wheel 42 is used to assist the cabinet 4 in moving. Four cabinet fixing holes 43 are arranged on the outer surface of the cabinet 4. Two of the cabinet fixing holes 43 are vertically arranged in an upper fixing area 45 of the cabinet 4 (as shown in FIG. 3), and the other two of the cabinet fixing holes 43 are arranged horizontally in a lower fixing area 46 of the cabinet 4 (as shown in FIG. 6). The four cabinet fixing holes 43 are used to combine and fix the anti-overturning device 10. The anti-overturning device 10 includes a first fixing component 1, a second fixing component 2 and a connecting part 3. One end of the first fixing component 1 is joined to one end of the second fixing component 2, so that the first fixing component 1 and the second fixing component 2 are vertical or close to vertical. The connecting part 3 is joined between the first fixing component 1 and the second fixing component 2 to increase the support strength and reinforcement of the anti-overturning device 10 when it is tipped over, so that the first fixing component 1 and the second fixing component 2 remain vertical to each other and not easily deformed by external forces. The embodiment does not limit how the first fixing component 1, the second fixing component 2 or the connecting part 3 are connected to each other, for example: welding, bonding, or snapping, etc., as long as the first fixing component 1, the second fixing component 2 and the connecting part 3 can be connected and fixed without being easily loosened, which all belong to the scope protected by the present invention.

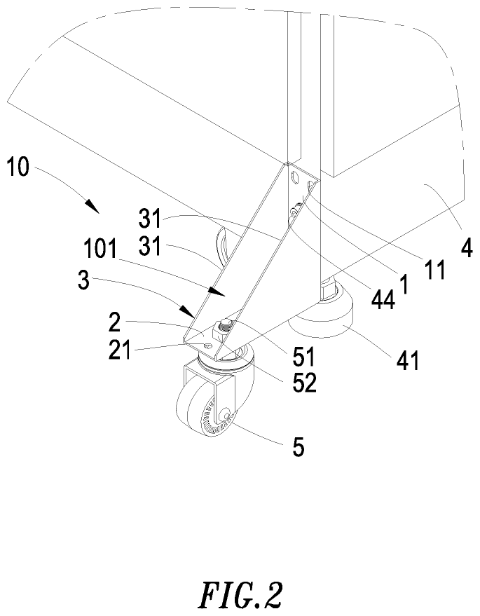

In this embodiment, four first openings 11 are disposed on the surface of the first fixing component 1. The four first openings 11 are all circular holes. The circular first opening 11 is merely for passing through one locking component 44. Two of the first openings 11 are arranged vertically in the middle of the first fixing component 1, and the other two first openings 11 are arranged horizontally above the first fixing component 1. Please refer to FIGS. 2 to 4, which further disclose various views of the first embodiment of the anti-overturning device 10 after being assembled with the cabinet 4, especially the first fixing component 1 is assembled in the upper fixing area 45. The positions of the two first openings 11 in the middle of the first fixing component 1 correspond to the positions of the cabinet fixing holes 43 in the upper fixing area 45. One end of each of the two locking components 44 passes through the two first openings 11 respectively, and then lacks with the two cabinet fixing holes 43, so that the first fixing component 1 is locked in the upper fixing area 45 of the cabinet 4. Otherwise, when the two locking components 44 are disengaged from the two cabinet fixing holes 43, the first fixing component 1 can be removed from the upper fixing area 45 of the cabinet 4 and the anti-overturning device 10 can be removed from the cabinet 4. That is, the anti-overturning device 10 can be locked to the cabinet 4 or removed from the cabinet 4 based on needs. In this embodiment, the locking components 44 can be screws, and the cabinet fixing holes 43 can be holes corresponding to the screws. As long as the locking component 44 does not easily detach or fall out of the cabinet fixing holes 43, the present embodiment is not limited.

In addition, when the first fixing component 1 is assembled in the upper fixing area 45, the second fixing component 2 is used to assemble an auxiliary wheel 5. The second fixing member 2 is disposed with two second openings 21 on the end surface which is remote from the first fixing member 1. One of the second openings 21 is used to fix the auxiliary wheel 5. Specifically, the auxiliary wheel 5 has a fixing part 51. The fixing part 51 can pass through the second opening 21, and then be screwed on the fixing part 51 through a screw component 52 to fix the auxiliary wheel 5 to the second fixing component 2. In this embodiment, the screw component 52 may be a nut, and the fixing part 51 may be a screw corresponding to the nut. As long as the combination between the screw component 52 and the fixing part 51 cannot be easily separated, it falls within the scope protected by the present invention, and the present embodiment is not limited.

In this embodiment, the connecting part 3 includes two connecting plates 31. The two connecting plates 31 are respectively attached to both sides of the first fixing component 1 and the second fixing component 2, so that a semi-open chamber 101 of the anti-overturning device 10 is formed between the two connecting plates 31. The chamber 101 can prevent the locking component 44 or the screw component 52 from being exposed, and can effectively protect the locking component 44 or the screw component 52 from being easily loosened or damaged by collision or friction.

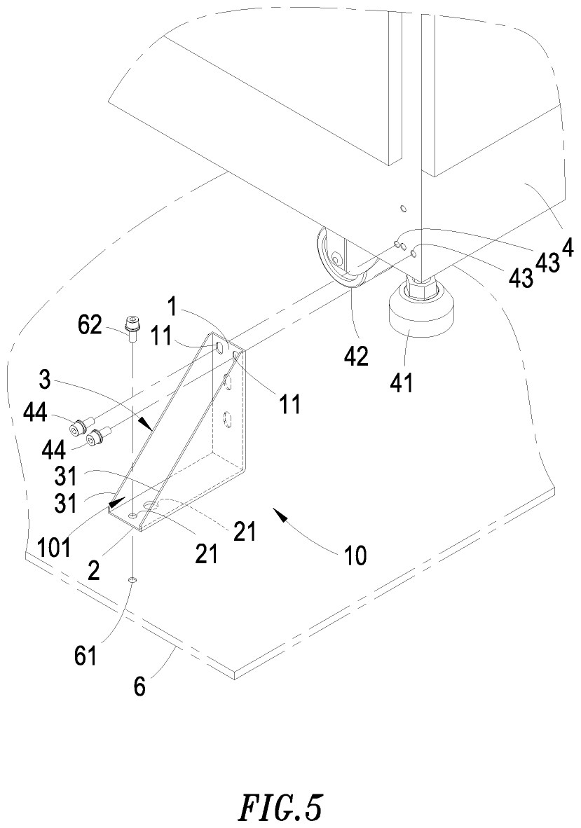

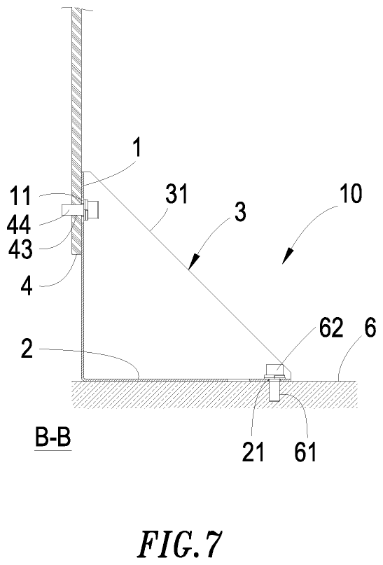

Please refer to FIGS. 5 to 7. The difference from the above FIGS. 2 to 4 is that the first fixing component 1 is assembled in the lower fixing area 46. The positions of the two first openings 11 above the first fixing component 1 correspond to the positions of the cabinet fixing holes 43 in the lower fixing area 46. One end of each of the two locking components 44 respectively passes through the corresponding two first openings 11, and then locks with the corresponding two cabinet fixing holes 43, so that the first fixing component 1 is locked in the lower fixing area 46 of the cabinet 4. Otherwise, when the two locking components 44 are departed from the two cabinet fixing holes 43, the first fixing component 1 can be removed from the lower fixing area 46 of the cabinet 4 and the anti-overturning device 10 can be removed from the cabinet 4. That is, the anti-overturning device 10 can be locked to the cabinet 4 or removed from the cabinet 4 based on needs.

In addition, when the first fixing component 1 is assembled in the lower fixing area 46, the second fixing component 2 is affixed to a ground 6. The position of another second opening 21 on the surface of the second fixing component 2 corresponds to the position of a ground fixing hole 61 on the ground 6, and one end of a ground bonding component 62 passes through the second opening 21 and locks with the ground fixing hole 61, so as to fix the second fixing component 2 to the ground 6. In this embodiment, the ground bonding component 62 may be using screws, and the ground fixing hole 61 may be screw holes corresponding to the screws. As long as the combination between the ground bonding component 62 and the ground fixing hole 61 cannot be easily separated, it falls within the scope protected by the present invention, and the present embodiment is not limited. In addition, the chamber 101 formed between the two connecting plates 31 can prevent the ground bonding component 62 from being exposed, and can effectively protect the ground bonding component 62 from being easily loosened or damaged by collision or friction.

As illustrated in FIGS. 1 to 7 above, it can be understood that the anti-overturning device 10 is used to assemble the auxiliary wheel 5 when it is assembled in the upper fixing area 45 of the cabinet 4. When the anti-overturning device 10 is assembled in the lower fixing area 46 of the cabinet 4, it is used to assemble on the ground 6 to switch between two different implementation states. As illustrated in FIGS. 1 to 4, when the second fixing component 2 is equipped with the auxiliary wheel 5, the cabinet 4 can be moved in a time-saving and labor-saving way through the bottom wheel 42 of the cabinet 4 and the auxiliary wheels 5 installed by the anti-overturning device 10, and the cabinet 4 can be prevented from tipping over during the moving process. As illustrated in FIGS. 5 to 7, when the second fixing component 2 is fixed on the ground 6, the cabinet 4 can be fixed to the ground 6 by the positioning column 41 of the cabinet 4 and the anti-overturning device 10 to achieve the effect of anti-overturning and anti-vibration.

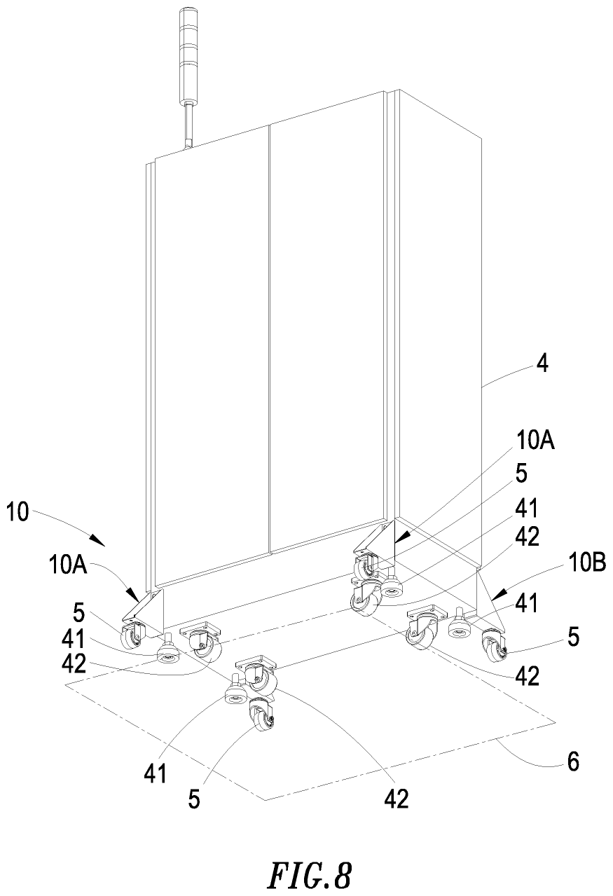

Please refer to FIG. 8 simultaneously. In this embodiment, the cabinet 4 can be a welded cabinet or an extruded aluminum cabinet, and is rectangular in shape. There are four corners at the bottom of the cabinet 4 (only three corners are shown due to blocked viewing angles). The width of the front and back sides is wider, which makes them easier to fall over than the narrower left and right sides. Therefore, four anti-overturning devices 10 are installed at the four corners of the bottom of the cabinet 4. Specifically, the four anti-overturning devices 10 include two first anti-overturning devices 10A and two second anti-overturning devices 10B. The two first anti-overturning devices 10A are disposed at the front of the bottom outer surface of the cabinet 4 (the upper fixing area 45 or the lower fixing area 46), and the second anti-overturning device 10B are disposed at the back of the bottom outer surface of the cabinet 4 (the upper fixing area 45 or the lower fixing area 46). The positions of the two first anti-overturning devices 10A correspond to the positions of the second anti-overturning device 10B. The above statement does not limit the number or position of the anti-overturning devices 10 installed in the cabinet 4. For example, there may be four anti-overturning devices 10 installed at the four corners of the cabinet 4.

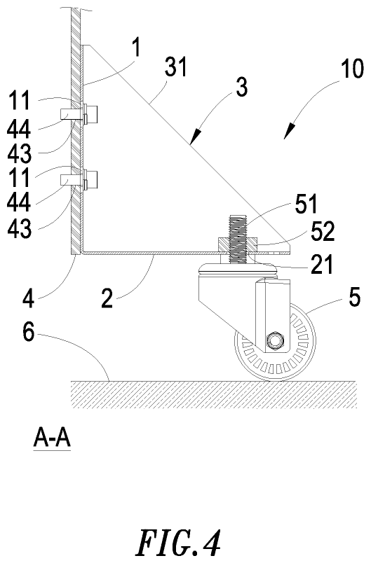

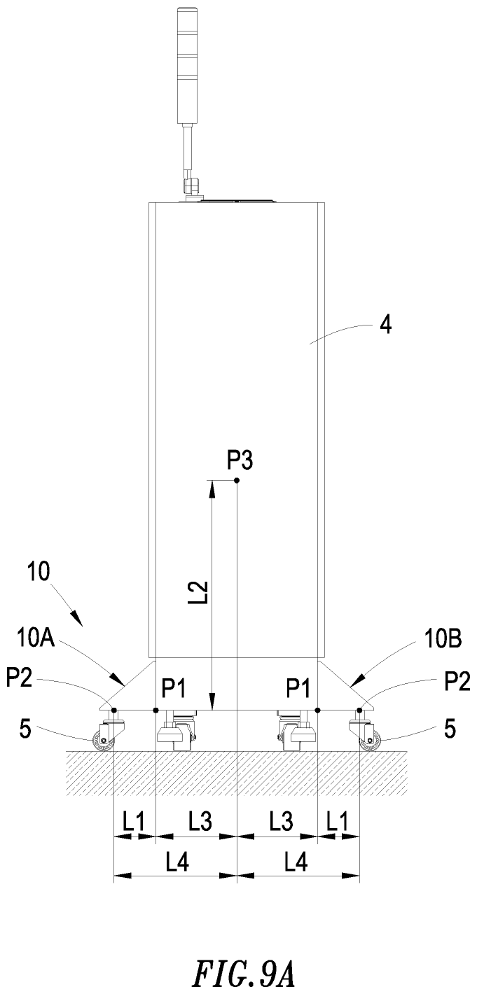

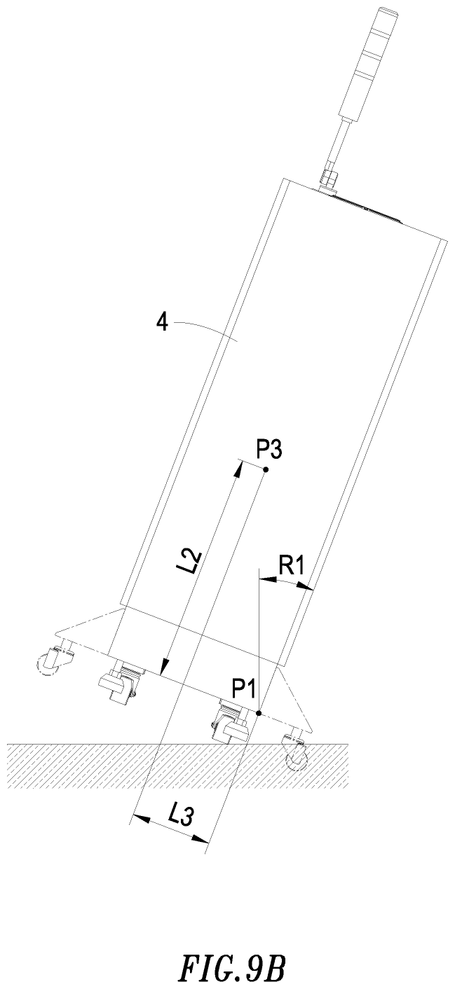

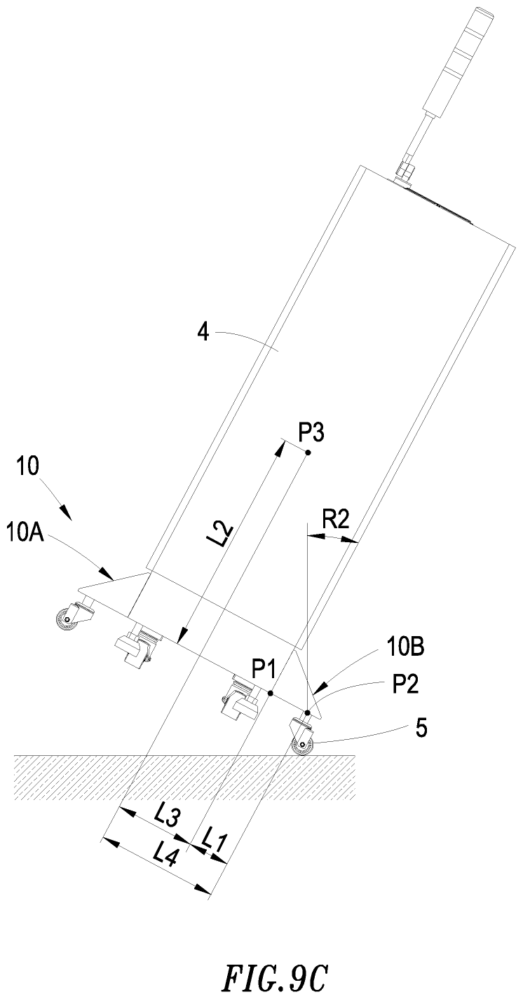

Please refer to FIG. 9A. When the anti-overturning device 10 is not installed on the cabinet 4, the tilt pivot P1 of the cabinet 4 is located on the outer surface position of the cabinet 4. After the anti-overturning device 10 is installed, the tilt pivot P2 of the cabinet 4 is horizontally shifted to the position of the second opening of the fixed auxiliary wheel 5 (not shown in the figure, details are illustrated in FIG. 4), so as to lengthen the horizontal distance from the gravity center P3 of the cabinet 4 to the tilt pivot of the cabinet 4. It should be noted that, in practice, the position of the gravity center P3 of the cabinet 4 may deviate depending on the objects contained inside the cabinet 4. However, for ease of illustration and understanding, in this embodiment, the gravity center P3 of the cabinet 4 is set at the center position of the cabinet 4.

Therefore, the distance between the tilt pivot P1 and the tilt pivot P2 can be defined as an anti-overturning distance L1, and an anti-overturning angle can be calculated from the anti-overturning distance L1. The anti-overturning angle refers to the maximum angle at which the cabinet 4 does not turn over when tilted. In other words, as long as the tilt angle is smaller than the anti-overturning angle, the cabinet 4 will not be turned over. The anti-overturning angle is calculated as follows. Please refer to FIG. 9B, the cabinet 4 shown in the figure is not equipped with an anti-overturning device 10 (to avoid confusion with FIG. 9C, the anti-overturning device 10 in FIG. 9B is drawn with a chain line). In this embodiment, it is assumed that the vertical distance L2 from the gravity center P3 of the cabinet to the bottom surface of the cabinet 4 is 650 cm, and the first horizontal distance L3 from the gravity center P3 of the cabinet to the tilt pivot P1 at the outer surface of the cabinet 4 is 250 cm. Calculating the inclination angle R1 without the anti-overturning device 10 yields

$${tan}^{- 1} \frac{250}{650} = 21 ° .$$

Please refer to FIG. 9C, the cabinet 4 shown in the figure is equipped with the anti-overturning device 10. In this embodiment, the vertical distance L2 from the gravity center P3 of the cabinet to the bottom surface of the cabinet 4 is 650 cm, and the second horizontal distance L4 from the gravity center P3 of the cabinet to the tilt pivot P2 of the second opening is 350 cm (equivalent to 250 cm of the first horizontal distance L3 and 100 cm of the anti-overturning distance L1). Calculating the inclination angle R2 with the anti-overturning device 10 yields

$${tan}^{- 1} \frac{350}{650} = 28.3 ° .$$

Therefore, it is proved that after installing the anti-overturning device 10, an anti-overturning distance L1 from the outer surface is extended for the cabinet 4, in order to further increase the anti-overturning angle. The greater the anti-overturning angle, the less likely the cabinet 4 will turn over.

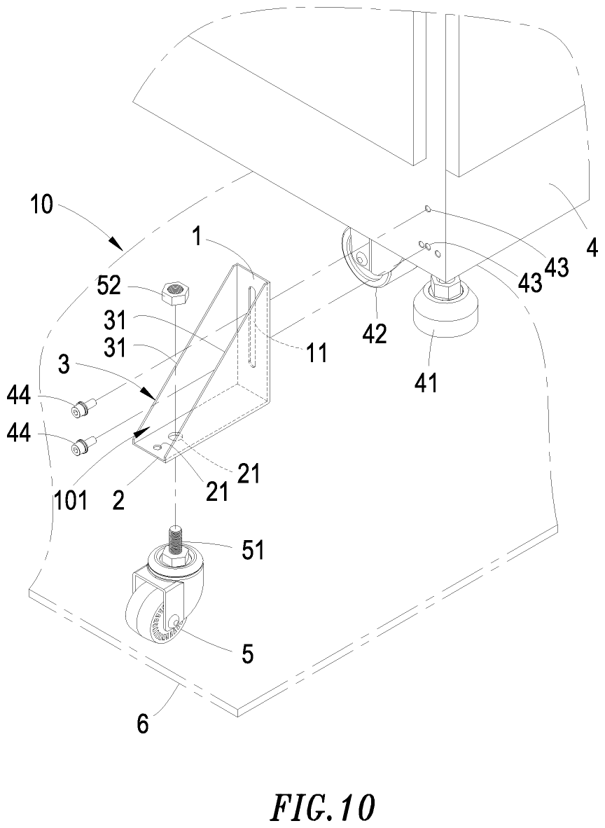

Please refer to FIG. 10, which illustrates a second embodiment of the anti-overturning device 10. The difference from the first embodiment is that the first opening 11 is a single and straight long hole, which can be passed through by multiple locking components 44 at the same time. In this way, the straight long first opening 11 can be free from the limitation of aperture diameter, and it is easy to fine-tune the height position of the anti-overturning device 10.

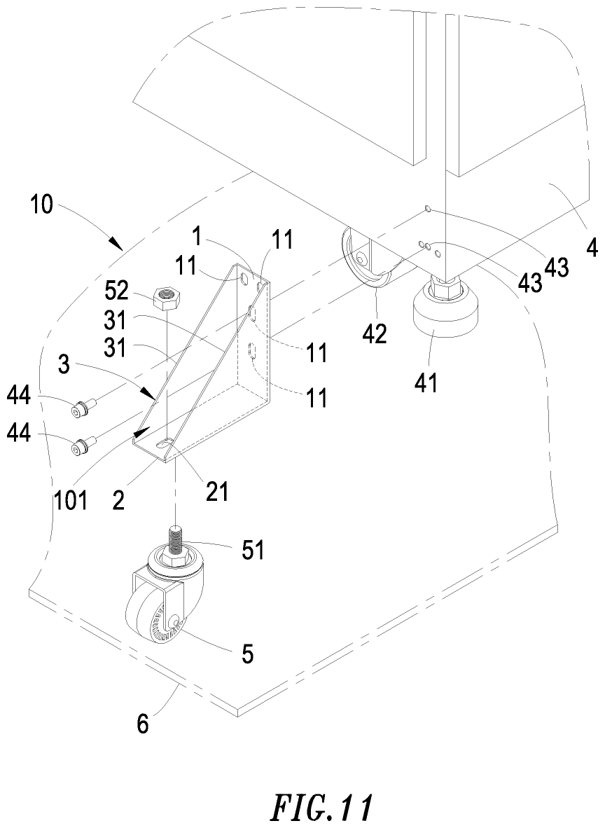

Please refer to FIG. 11, which illustrates a third embodiment of the anti-overturning device 10. The difference from the first embodiment is that the second opening 21 is a single and elliptical hole, and is used for passing through only one fixing part 51 or a ground bonding component 62. The same second opening 21 is shared when the second fixing component 2 is assembled with the auxiliary wheel 5 or the ground 6 respectively.

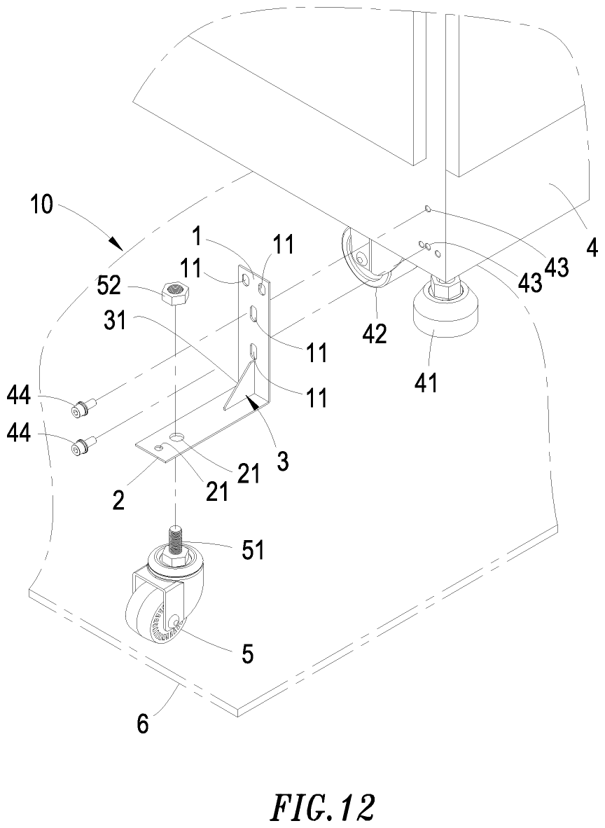

Please refer to FIG. 12, which illustrates a fourth embodiment of the anti-overturning device 10. The difference from the first embodiment is that the connecting part 3 includes a single connecting plate 31. The connecting plate 31 joins the two adjacent surfaces of the first fixing component 1 and the second fixing component 2. In this way, a single connecting plate 31 uses less material, and it can be joined to the first fixing component 1 and the second fixing component 2 in a single process, making it easier to manufacture.

The above anti-overturning device 10 has various embodiments. No matter which embodiment it is, the first fixing component 1, the second fixing component 2 or the connecting part 3 can be made of a flat metal material. The rigidity of the metal material provides effective support strength, and the flat shape is easy to manufacture. This embodiment does not limit the material and shape of the first fixing component 1, the second fixing component 2 or the connecting part 3. As long as it can be joined and provide supporting strength, it should fall within the scope of the first fixing component 1, the second fixing component 2 or the connecting part 3.

To sum up, the anti-overturning device 10 installed on the cabinet 4 increases the anti-overturning angle, making it difficult for the cabinet 4 to turn over, effectively preventing important equipment in the cabinet 4 from being hit due to tipping and further causing significant economic losses.

The above disclosed embodiments are merely some of the preferred embodiments of the present invention, which are not intended to limit the present invention. Any person of ordinary knowledge in the art may make certain changes and modifications in understanding the foregoing technical features and embodiments of the present invention without departing from the spirit and scope of the present invention. Accordingly, the scope of patent protection for the present invention shall be as defined in the claim attached hereto.

What is claimed is:

1. An anti-overturning cabinet structure, comprising:
a cabinet, wherein a bottom outer surface of the cabinet has an upper fixing area and a lower fixing area;
a plurality of anti-overturning devices, wherein each of the anti-overturning devices has a first fixing component, a second fixing component and a connecting part, the first fixing component is detachably fixed on the bottom outer surface of the cabinet, the second fixing component has at least one second opening, and the connecting part is joined between the first fixing component and the second fixing component; and
a plurality of auxiliary wheels;
wherein the anti-overturning devices comprises at least one first anti-overturning device and at least one second anti-overturning device, a number of the first anti-overturning devices is equal to a number of the second anti-overturning devices, they are optionally disposed on two opposite sides of the upper fixing area or the lower fixing area, and when the first anti-overturning devices and the second anti-overturning devices are fixed on the upper fixing area, each auxiliary wheel is locked in the second opening of each of the second fixing components.

2. The anti-overturning cabinet structure according to claim 1, wherein the first anti-overturning devices are disposed on a front side of the upper fixing area, the second anti-overturning devices are disposed on a back side of the upper fixing area, and positions of the first anti-overturning devices correspond to positions of the second anti-overturning devices.

3. The anti-overturning cabinet structure according to claim 1, wherein the first anti-overturning devices are disposed on a front side of the lower fixing area, the second anti-overturning devices are disposed on a back side of the lower fixing area, and positions of the first anti-overturning devices correspond to positions of the second anti-overturning devices.

4. The anti-overturning cabinet structure according to claim 1, wherein an anti-overturning distance is used to calculate an anti-overturning angle, and a calculation formula of the anti-overturning angle is as follows:
$${tan}^{- 1} \frac{L 1 + L 3}{L 2} ;$$
wherein in the calculation formula, L1 is the anti-overturning distance, L2 is a vertical distance from a gravity center of the cabinet to a bottom surface of the cabinet, and L3 is a horizontal distance from the gravity center of the cabinet to an outer surface of the cabinet.

5. The anti-overturning cabinet structure according to claim 1, wherein one end of the first fixing component is joined to one end of the second fixing component.

6. The anti-overturning cabinet structure according to claim 1, wherein the first fixing component is vertical to the second fixing component.

7. The anti-overturning cabinet structure according to claim 1, wherein the connecting part comprises two connecting plates, and the connecting plates are respectively joined to both sides of the first fixing component and the second fixing component.

8. The anti-overturning cabinet structure according to claim 1, wherein the connecting part comprises a connecting plate, and the connecting plate is joined to two adjacent surfaces of the first fixing component and the second fixing component.
